(19) United States
(12) Patent Application Publication
(10) Pub. No.: US 2006/0202840 A1
(43) Pub. Date: Sep. 14, 2006

(54) Portable remote locator device

(76) Inventor: Jon Korbonski, Irvine, CA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/348,516

(22) Filed: Feb. 6, 2006

Related U.S. Application Data
(60) Provisional application No. 60/650,426, filed on Feb. 4, 2005.

(51) Int. Cl. G08B 23/00; G08B 1/08; G08B 21/00

(52) U.S. Cl. 340/573.4; 340/539.11; 340/539.32; 340/539.21; 340/539.26; 340/686.6

(57) ABSTRACT

A portable remote locator device is disclosed. The portable remote locator device includes a first transceiver adapted to mounting on an electronic device carried by a first user, including a proximity switch, a proximity alarm, a power source, a speaker and an alarm indicator; and a second transceiver in communication with the first transceiver, adapted to mounting on an electronic device carried by a second user, including a mode selection switch, an alarm signal button, a power source, a speaker and an alarm indicator.

### CROSS REFERENCE TO RELATED APPLICATIONS

This application claims benefit to provisional application 60/650,426, filed on Feb. 4, 2005, entitled Portable Remote Locator Device, which is incorporated by reference herein in its entirety.

### FIELD OF THE INVENTION

The present invention relates to the field of locator devices, and in particular to a portable remote locator device that can be placed on a variety of portable everyday devices.

### BACKGROUND OF THE INVENTION

The ability to remotely monitor a child, or other loved one who may need care, has become very critical to those who need to be able to go about their daily chores without physically supervising the person. To this end, various devices have been introduced to the market to aid a parent in keeping track of his or her child throughout a location. In general, a number of devices directed to electronic proximity/locator devices have been introduced into the market.

U.S. Pat. No. 6,078,260 is directed to a system for monitoring the proximity and location of a child by a parent that includes two transceiver units which communicate wirelessly. The child unit will transmit a signal to the parent unit so that the parent unit can determined the proximity of the child unit and its direction. A safe zone may be set by controls on the parent unit. When the child unit moves beyond the safe zone, the parent unit will generate an alert.

U.S. Pat. No. 5,841,352 is directed to a monitor system comprising first and second watches for wear by first and second users of the system. Each watch includes a battery therein for powering a transmitter and receiver. A signal limiter provides a base signal to a comparator so that the comparator can compare the base signal to a transmitted signal from one watch as received by the receiver of the other watch. Upon the received signal being less than the base signal, the comparator closes a relay which in turn energizes an alarm. The alarm indicates that an undesired amount of separation has occurred between the two watches. The strength of the signal produced by the signal limiter can be varied such that the desired degree of separation between the watches, which energizes the alarm, can be varied. A panic button is provided so that an alarm in one watch can be energized by the user of another watch irrespective of the distance between watches. The use of the monitor system in a watch-type configuration allows for its unobtrusive use.

U.S. Pat. No. 5,311,185 is directed to a monitoring assembly which monitors the location of mobile objects, i.e., personnel, within a structure. The object carries a transponder which periodically transmits status signals and receives command signals relating to audio control. Transceivers are fixed at locations about the structure for receiving the status signal producing the location signals, and transmitting commands to the transponders. The transmissions and reception occur during prescribed time windows. A controller is connected to each transceiver and monitors the location of transponders and communication there through. The transponders have audio capability of producing audio messages directly to the person thereof.

U.S. Pat. No. 6,127,931 is directed to a device for monitoring the movement of a person including a homing unit and a base unit. The homing unit includes a device for generating a homing signal and a transmitter for transmitting the homing signal at predetermined intervals. The base unit includes a receiver for receiving the homing signal, a processor for processing the homing signal to determine whether the homing unit is within a predetermined distance from the base unit and generating an alarm signal upon determining the homing unit is at a distance from the base unit greater than the predetermined distance. An alarm is provided on the base unit for alerting a user that the homing unit has moved a distance greater than the predetermined distance from the base unit upon receipt of the alarm signal from the processor. The alarm is at least one of an audible alarm, a visible alarm and a vibratory alarm. At least one of the base unit and homing unit includes a device for adjusting the predetermined distance. The processor determines a time between receipt of sequentially transmitted homing signals to determine the distance between the base unit and homing unit. The base unit further includes a display for displaying the distance between the base unit and homing unit and a direction to the homing unit from the base unit.

U.S. Pat. No. 4,785,291 is directed to a monitoring apparatus including an unmodulated radio-frequency transmitter carried by or affixed to the person to be monitored and receiver/monitor apparatus at a monitoring location for providing quantized visual and audible indicia based on received signal strength. The receiver AGC level, being a function of received signal strength, provides the variable which determines the repetition rate of tone bursts and the number of LED bar visual indicia lighted within an array of such LED bars. The response levels of those indicia are then a function of the distance between transmitter and receiver. Movement of the child (for example) beyond a predetermined range is immediately detected by a person at the receiver location. Circuitry is provided for presetting the maximum allowable range before alarm is instituted.

U.S. Pat. No. 5,589,821 is directed to a system which generates an alarm at one unit of the system when a second unit of the system is more than a predetermined distance from the first unit. The system has a first transceiver unit with a first transmitter for transmitting a first reference signal having a phase with respect to a reference source, and a first receiver for detecting a second reference signal having a phase which bears a relationship to that of the first reference signal. There is a second, portable, transceiver unit with a second transmitter for transmitting the second reference signal after receipt of the first reference signal. The first transceiver unit includes a distance resolver for determining the distance between the two transceiver units from the phases of the first and second reference signals, and an alarm, responsive to the distance resolver, for generating an alarm signal if the distance between the two transceiver units is more than a predetermined amount.

U.S. Pat. No. 5,021,794 is directed to a radio transmitter in a miniaturized transceiver concealed on a person to be located, such as a lost child that is activated and transmits a coded UHF radio homing signal upon receipt of an initiating signal containing the child's address code. The initiating signal is automatically transmitted by a repeater station in response to an audible “panic signal” containing the address code and contains the identical address code. The panic signal is a pulse tone produced by a hand held tone generator activated by the child's parent and is transmitted to the repeater station by telephone. Tracking vehicles are provided with automatic UHF radio direction finding and distance measuring equipment for locating the source of the homing signal. Stored information concerning the child can be transmitted to the tracking vehicles.

U.S. Patent Application No. 2003/0162508 is directed to an electronic personal locator (EPL) having a first inner housing containing a radio frequency signal generator connected to an antenna. The inner housing is located inside a second outer housing which contains activation means for activating the signal generator and a power source, both of which are operatively connected to the radio frequency generator. The antenna has a fixed shape which allows it to transmit a constant radio frequency output for a given input power and the EPL is of a compact design such that it can be conveniently worn by a person.

U.S. Pat. No. 6,788,199 is directed to a system and method for locating objects such as people, pets, and personal articles is described. A transceiver is attached to the person, animal, or item to be tracked and a handheld locator device is employed to transmit a locator signal containing an address code to the transceiver. Upon receipt of a signal, the transceiver compares the address code contained in the locator signal with an address code stored in the transceiver. If the two codes are same, the transceiver sends a return signal back to the locator device. The locator device uses this return signal to determine the distance and/or direction of the transceiver from the user's location. The system allows a user to select from a multiple number of items to locate and allows multiple users to search for different articles within the same general area without interference.

U.S. Pat. No. 5,900,817 is directed to a monitoring system for indicating to a supervisory individual, such as an adult, when a monitored individual, such as a child, has moved beyond a safe predefined maximum distance limit. The monitoring system includes a first electronic module suitably fixed to the monitored individual and arranged to exchange signals that are useful to determine the relative distance and direction the first electronic module is from a suitable second electronic module. The second electronic module, which is in the possession of the supervisory individual, is arranged to exchange signal information with the first electronic module and indicate to the supervisory individual information including when the distance between, and the direction of, the monitored individual. Should the distance between the monitored and supervisory individuals increase beyond the maximum distance limit, an alarm situation may be annunciated by an audio enunciator (or other suitable annunciation device). The second electronic module includes a direction display and distance display that may be employed by the supervisory individual to locate the monitored individual.

There is a need however for a portable remote locator device that can be mounted on a multitude of everyday portable devices that a child or other person might use, such as a pager, cell phone, PDA, and the like. None of the above references disclose such as device, and it would be extremely advantageous if one existed in the marketplace.

### OBJECTS AND SUMMARY OF THE INVENTION

It is an object of the present invention to provide a portable remote locator device that can be placed on a multitude of personal user devices, such as a cellular phone, PDA, pager, portable MP3 player, and the like.

In accordance with a first aspect of the present invention, a novel portable remote locator device is provided. The novel portable remote locator device includes a first transceiver adapted to mounting on an electronic device carried by a first user, including a proximity switch, a proximity alarm, a power source, a speaker and an alarm indicator; and a second transceiver in communication with the first transceiver, adapted to mounting on an electronic device carried by a second user, including a mode selection switch, an alarm signal button, a power source, a speaker and an alarm indicator.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a perspective view of transceivers of a portable remote locator device shown separated in accordance with the present invention.

FIG. 2 is a perspective view of the transceivers of the portable remote locator device of FIG. 1 shown connected.

FIG. 3 is a top plan view of the transceivers of the remoter locator device of FIGS. 1 and 2.

FIGS. 4 and 5 constitute an alternative embodiment of the present invention.

### DETAILED DESCRIPTION OF THE PREFERRED EMBODIMENT

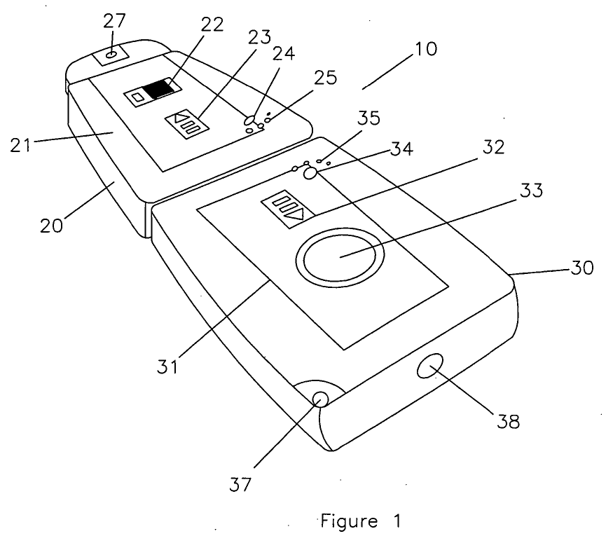

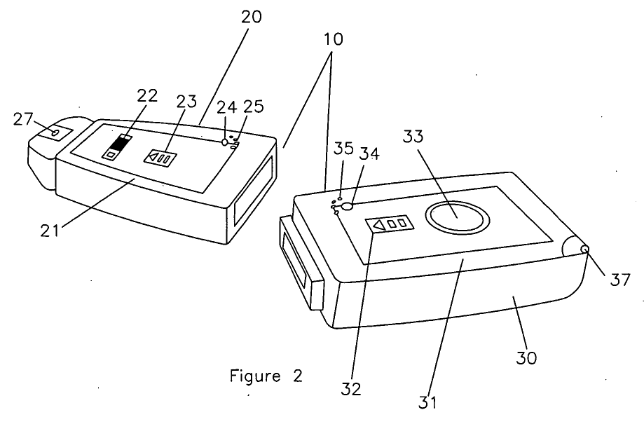

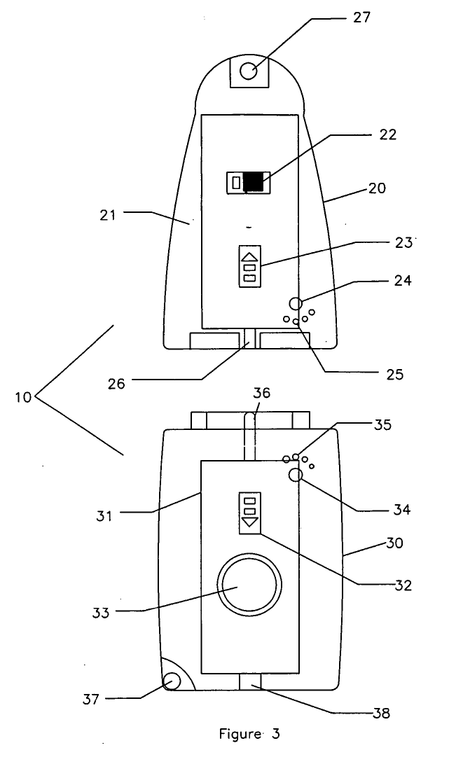

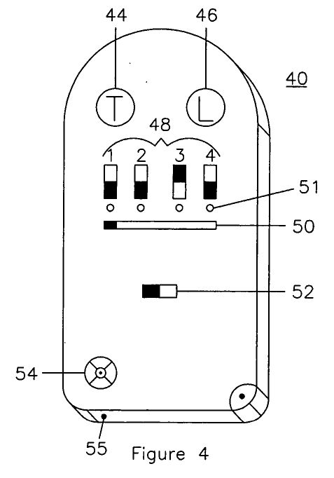

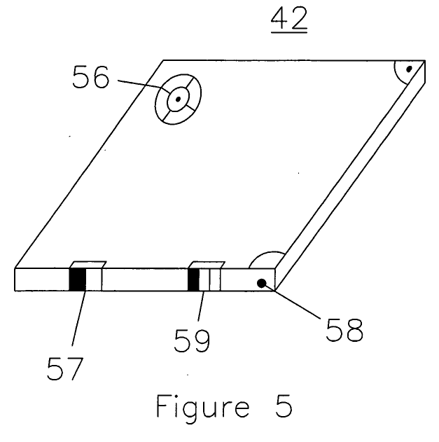

Referring now to the drawings, wherein like reference numerals refer to the same components across the several views and in particular to FIGS. 1, 2 and 3, there is shown a portable remote locator device 10. The portable remote locator device includes a first transceiver 20 and a second transceiver 30. The first transceiver 20 and the second transceiver 30 are in communication with one another. In a preferred embodiment of the present invention, the first transceiver 20 and the second transceiver 30 are in radio communication with one another, however, any known communications means to one of ordinary skill in the art may be utilized.

The first transceiver 20 includes a housing 21, adapted to be placed on an electronic device, such as a cellular phone, PDA, pager, portable MP3 player, and the like. Mounted on a face of the housing are a distance selection switch 22, a proximity alarm switch 23, an alarm indicator 24, and a speaker 25. A connector 26 is disposed at a first end of the housing 21, to connect the first transceiver 20 to the second transceiver 30, for charging, and the like. An attachment hole 27 is disposed at a second end, opposite the first end, for attaching the first transceiver 20 to an item to be carried by a user.

The distance selection switch 22 of the first transceiver 20 can be set so that the first transceiver 20 can only travel a predetermined distance from the second transceiver 30. For example, if the first transceiver 20 travels beyond the predetermined distance from the second transceiver 30, a speaker 35 on the second transceiver 30 will sound a proximity alarm to alert the users at both the first transceiver 20 and the second transceiver 30 that the first transceiver 20 has traveled beyond the predetermined distance. The proximity alarm switch 23 can be used to turn on or off the proximity alarm so that it will sound or not sound, depending on the proximity of the first transceiver 20 from the second transceiver 30. The alarm indicator 24, in a preferred embodiment is a light emitting diode (LED), and illuminates whenever the proximity alarm sounds. Additionally, the alarm indicator 24 can be used to indicate that a power source, such as a battery (not shown), which is incorporated into the housing 21, is getting low on power.

The second transceiver 30 includes a housing 31, adapted to be placed on a portable device such as a cellular phone, PDA, pager, portable MP3 player, and the like. Mounted on a face of the housing are a mode selection switch 32, a proximity alarm signal button 33, an alarm indicator 34, and the speaker 35. A connector 36 is disposed at a first end of the housing 31, to connect to the connector 26 of the first transceiver 20 for charging, and the like. An attachment hole 37 is disposed at a second end, opposite the first end, for attaching the second transceiver 30 to an item to be carried by a user. A plug 38 is disposed at a second end of the second transceiver 30 to attach the second transceiver 30 to an external power source for charging the power sources (not shown) within the first transceiver 20 and the second transceiver 30.

The mode selection switch 32 can be used to cycle between a variety of functions, such as turning the power on and off to the unit, turning the proximity alarm on and off, and activating the locator function of the portable remote locator device 10. The alarm signal button 33, when depressed, sends a signal from the second transceiver 30 to the first transceiver 20 to cause the proximity alarm to sound through the speakers 25 of the first transceiver 20 regardless of whether the first transceiver 20 is within the boundaries of the predetermined distance. In this manner, for example, a parent who is using the second transceiver 30 can locate audibly a child, equipped with the first transceiver 20. The alarm indicator 34, in a preferred embodiment is a light emitting diode (LED), and illuminates whenever the proximity alarm sounds. Additionally, the alarm indicator 34 can be used to indicate that the power source, such as the battery (not shown), which is incorporated into the housing 31, is getting low on power. The plug 38 allows the power source to be recharged by an external power source such as an AC outlet and the like. The second transceiver 30 can provide throughput power to the first transceiver 20 via their respective connectors 36 and 26 to charge the power source in the first transceiver 20.

The housings 21 and 31 of the first and second transceivers, 20 and 30, respectively, are formed of a high impact plastic in a preferred embodiment of the present invention and are in wireless communication with each other. In a preferred embodiment of the present invention, the first transceiver 20 and the second transceiver 30 are in wireless communication via a radio signal, however, any means of wireless communication known to one of ordinary skill in the art may be employed.

In view of the foregoing disclosure, some advantages of the present invention can be seen. For example, a novel portable remote locator device that can be attached to a portable item is disclosed. The novel portable remote locator can be placed on a variety of portable items, such as a pager, cellular phone, PDA, MP-3 player and the like, and will allow a person to monitor the location of the device. The small size of the invention allows for a person such as a parent to easily attach the device to either a portable device to monitor the location of another, such as a child. Additionally, since the unit can be miniaturized, the device can be incorporated into a case directly attached to the portable device, which could hold the above portable items and the like. The portable remote locator can also operate as a proximity device in that, if the two transceivers are separated from one another beyond a predetermined distance, an alarm will sound. The transceivers can also be configured to communicate with other electronic devices using commercial protocols, such as those utilized by BLUETOOTH and the like. In this manner, the transceivers can communicate with a wide variety of useful portable devices and a plurality of transceivers can be tracked by, for example, a parent.

In still further embodiment, the invention the electronic proximity alarm/locator: is described in the context of mother and daughter unit. The mother comprises of a setup button 44, LOCATE button 46, two-position switch (on/off) for proximity function 48, LED light 51, four-position switch for daughter selection 50, two-position switch (on/off) for vibration 52, AC Adaptor plug 55, speaker for audible alarm 54.

The daughter includes a speaker for audible alarm 56, two-position switch (on/off) for proximity function 57, three-position switch-distance selector 59, and AC Adapter plug 58.

The daughter is adjustable to multiple distances for different applications (4M for consumer products, 8M for children, 15M for pets, etc.) using switch 59. The system is designed to work even when the power is off and the locator function is still working. An audible alarm package may be built into consumer products and still managed by the same mother remote. Each daughter transmits a multiple character code accordingly, the respect of two daughters having the same code being in the same proximity are very remote.

The mother unit comprises a transceiver which includes set up function 44. This allows the mother to set up contact with any daughter in one of four control positions. Existing daughters can be overwritten so same mother can be used to manage multiple daughters (e.g. 6 daughters but only 4 at a time) initiates LOCATE function 46, audible, visual, and vibration alarm.

The operation of this embodiment is described as follows. The mother exchanges a signal with daughter at preset interval (e.g. once every 3 seconds). When mother does not receive a signal from the daughter, the mother alarm is activated, by means of optional, light, audible, vibration. The user moves a selector switch 50 to number that is alarming and pushes LOCATE function 46.

This activates the audible alarm on the selected daughter so user can find the daughter. For the set up, the daughter unit is turned off 57 except the new daughter. The user puts the selector switch 50 to desired position and holds the set up button 44 down for 5 seconds. The mother will beep 54 when the daughter has been set up.

When not using the proximity function, the switches 48 on the mother and the daughter 57 units should be put in the off position. The mother has an optional vibration alert 52 that can be turned on or off.

Due to it's small, flat design, the daughter unit can be used for tracking children, pets, personal articles (e.g. keys, purses, etc) or it can be built into protective cases for consumer electronics (e.g. ipod, MP3 players, laptop computers, portable gaming systems, cellular phones, etc).

In a previous application, the invention can also include a larger then normal battery and can be utilized as a back-up battery for the consumer electronics. If desired, the daughter package and functionality can be built into consumer electronics so that the electronic device can be managed by a common remote.

The small size compiled with set up function will allow the user to manage a multitude of items, people, etc. at the same time. For example, one use can manage a child, cellular telephone, pet, and keys. All items can be set to different proximity alarm distances, which would be selected by user, depending on conditions. For example, in an open space, the user may select 8M for the child. In a crowded or noisy location, the user may change the distance for the child to 4M.

While the preferred embodiment of the present invention has been described and illustrated, modifications may be made by one of ordinary skill in the art without departing from the scope and spirit of the invention as defined in the appended claims. For example, in a preferred embodiment of the present invention, the alarm indicator is an LED, however, any indicator known to one of ordinary skill in the art may be employed as the alarm indicator. Additionally, in a preferred embodiment of the present invention, the power source for the transceivers is a battery, however, any power source known to one of ordinary skill in the art may be employed.

What is claimed is:

1. A portable remote locator device, comprising:
a first transceiver adapted to mounting on an electronic device carried by a first user to be located, including a proximity switch, a proximity alarm, a power source, a speaker and an alarm indicator; and
a second transceiver in communication with the first transceiver, adapted to mounting on an electronic device carried by a second user, including a mode selection switch, an alarm signal button, a power source, a speaker, set up mechanism, and an alarm indicator.

2. A portable remote locator device, comprising:
a first transceiver adapted to mounting on an electronic device carried by a first user, including a proximity switch, a proximity alarm, a power source, a speaker and an alarm indicator; and
a second transceiver in communication with the first transceiver, adapted to mounting on an electronic device carried by a second user to be located; including a mode selection switch, an alarm signal button, a power source, a speaker and an alarm indicator.

3. A method for setting a portable remote locater device comprising:
using a first proximity device having an alarm to determine positioning a second proximity device
setting a distance by which the first proximity device activates at a predetermined distance from the second proximity device;
setting off an alarm on the first or second locator device exceeds the predetermined distance.
